(19) United States
(12) Patent Application Publication
(10) Pub. No.: US 2024/0134385 A1
(43) Pub. Date: Apr. 25, 2024

(54) Robotic officer for police emergency assistance

(71) Applicant: Edgar Bonilla, Chino HIlls, CA (US)

(72) Inventor: Edgar Bonilla, Chino HIlls, CA (US)

(21) Appl. No.: 18/395,523

(22) Filed: Dec. 23, 2023

Related U.S. Application Data
(60) Provisional application No. 63/419,052, filed on Oct. 25, 2022.

(51) Int. Cl. G05D 1/224; B60Q 1/24

(52) U.S. Cl. CPC G05D 1/2247; B60Q 1/245; E01F 13/12

(57) ABSTRACT

This disclosure introduces methods and devices for robotic police officer assistance, incorporating an articulating spotlight, removable camera, spike strip delivery, and chemical agent dispenser, aiming to enhance officer safety during common police activities by allowing remote operation and minimizing the need for officers to be physically present in dangerous situations. Presented herein are methods and devices for robotic police officer assistance. The device comprises an articulating spotlight, a removeable camera, a spike strip delivery mechanism, and a chemical agent dispenser. The robot is controlled by a police officer so that the actions of the robot can be controlled from a position that is safe for the officer. By directing the robotic device, it is not necessary for an officer to be placed in in a dangerous position to conduct some of the most common police activities. When an officer is not required to put their personal safety on the line during common police activities, serious injury to police officers can be avoided. Also disclosed herein are methods of using the robotic device during police activities or emergencies that would otherwise require an officer to be put in harm's way.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

This disclosure relates to robotics. More specifically, the present subject matter is a controllable robotic device for use during police activities or emergencies.

### Background of the Invention

Part of the responsibility of a police officer is to protect and serve the public in the event of an emergency. In performing their duties, too often officers are required to put their lives at risk in dangerous situations. Ideally, it is preferred that officers are not put in harm's way when less dangerous alternatives could be employed. Technological advancements have allowed the risk of harm to officers to be reduced in many dangerous circumstances.

However, there remain many situations in which an officer's life is put at risk. Often, it is the most common, daily situations that present the most risk to police officers.

Law enforcement officers face significant risks during emergencies, and while technological advancements have reduced some dangers, there is still a need to protect officers during common but risky situations like dealing with barricaded individuals or deploying spike strips. More specifically, what is needed is an improved device that can assist an officer in the line of duty with these common, but dangerous tasks.

### SUMMARY OF THE INVENTION

The presently disclosed subject matter solves the problem or need identified above. This specification introduces a controllable robotic officer designed to aid law enforcement during emergencies. It incorporates an articulating spotlight, a removable live stream camera, a spike strip delivery mechanism, and a chemical agent dispenser, operated remotely to minimize risks to officers. In one embodiment, the disclosure presents a controllable robotic officer equipped with an articulating spotlight, removable camera, spike strip delivery, and chemical agent dispenser, aiding law enforcement in minimizing risks during emergencies. Presented herein are other embodiments and methods for robotic officer assistance in dangerous or emergency situations. In another preferred embodiment of the disclosure, a robotic device is described which incorporates an articulating spotlight, a removeable livestream camera, a spike strip delivery device, and a chemical agent delivery mechanism. The device also incorporates at least four wheels and is controlled via remote control or other remote means.

Presented herein are methods and devices for robotic officer assistance in dangerous emergency situations. In a preferred embodiment of the present invention, a robotic device is disclosed which incorporates an articulating spotlight, a removeable livestream camera, a spike strip delivery device and a chemical agent delivery mechanism. The device also incorporates at least four wheels and is controlled via remote control or other remote means.

This summary is not intended to disclose every embodiment or every aspect of the present subject. Rather, it is intended to provide an exemplification of some the concepts and features set forth herein. The features and advantages of this disclosure will be readily apparent from the following description of drawings and detailed description of the invention. This disclosure expressly includes any and all combinations and subcombinations of the elements and features presented herein.

### BRIEF DESCRIPTION OF THE SEVERAL VIEWS OF THE DRAWINGS

Other objectives of the disclosure will become apparent to those skilled in the art once the invention has been shown and described. The present invention will be understood more fully from the detailed description disclosed below and from the accompanying drawings of various embodiments of the present invention. The detailed description and drawings are intended to illustrate specific embodiments of the present invention and are not intended to limit the present invention. These specific embodiments are for explanation and understanding purposes only. That said, the manner in which these objectives and other desirable characteristics can be obtained is explained in the following description and attached figures in which:

FIG. 1. is an illustration of a top perspective view of one embodiment of the a robotic officer 1000 with a spotlight 1500 attached to an attachment base 1400 a and livestream camera 1300 attached and the topside of a chassis 1100;

FIG. 2 is a top view of the robotic officer 1000 of FIG. 1;

FIG. 3 is a schematic of the components of a robotic officer that are housed within the chassis 1100;

FIG. 4 is an environmental view illustrating a left rotating movement of the robotic officer;

FIG. 5A is an initial setting of a lift 1420 of the robotic officer

FIG. 5B is a lifted setting of a lift 1420 of the robotic officer;

FIG. 6 is an alternative configuration of the robotic officer 1000 with a pepper spray adapter 1600 attached to the attachment base 1400 of the robotic officer 1000.

1000—Robotic officer
1200—wheel
1210—drive axle
1220—motor
1230—RC receiver
1100—chassis
1110—on/off switch
1300—live-stream camera
1310—live-stream transmitter/receiver
1400—attachment base
1410—clamp
1411—clamp screw
1420—lift
1430—lift motor and drive
1440—lift RC receiver
1500—spotlight
1510—power cord.
1600—pepper spray device
1610—power cord for pepper spray
1620—pepper spray outlet
1630—pepper spray trigger
1640—trigger drive and/or motor
1650—trigger RC receiver

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. The present disclosure is amenable to various modifications and alternative forms. Some representative embodiments are shown by way of example in the drawings and will be described in detail herein. It should be understood, however, that the novel aspects of this disclosure are not limited to the particular forms illustrated in the above enumerated drawings. Rather, the disclosure is to cover all modifications, equivalents, combinations, permutations, groupings, and alternatives falling within the scope of this disclosure as encompassed by the appended claims. Also, figures are not necessarily made to scale but are representative.

### DETAILED DESCRIPTION OF PREFERRED EMBODIMENTS

The detailed description elucidates each component of the robotic officer, detailing its functionalities and how it aids officers in dangerous scenarios like directing light strategically, providing remote monitoring, deploying spike strips, and utilizing chemical agents from a safe distance. However, it's important to note that specific details are outlined in this description for a comprehensive understanding of the invention. Some structures and devices are depicted in block diagram form to maintain clarity and avoid obscuring the core aspects of the invention. The detailed description outlines each component of the robotic officer, its functionalities, and how it aids officers in dangerous situations such as directing light strategically, offering remote monitoring capabilities, deploying spike strips, and using chemical agents from a safe distance. But, again, it should be understood that in the following description, for purposes of explanation, numerous specific details are set forth in order to provide a thorough understanding of the invention. It will be apparent, however, to one skilled in the art, that the invention can be practiced without each specific detail. In other instances, structures and devices are shown in block diagram form to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

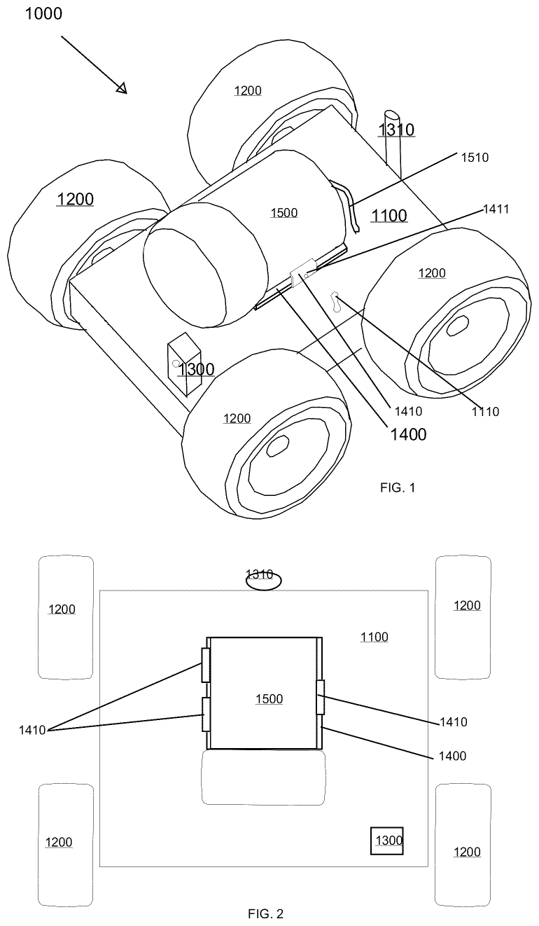

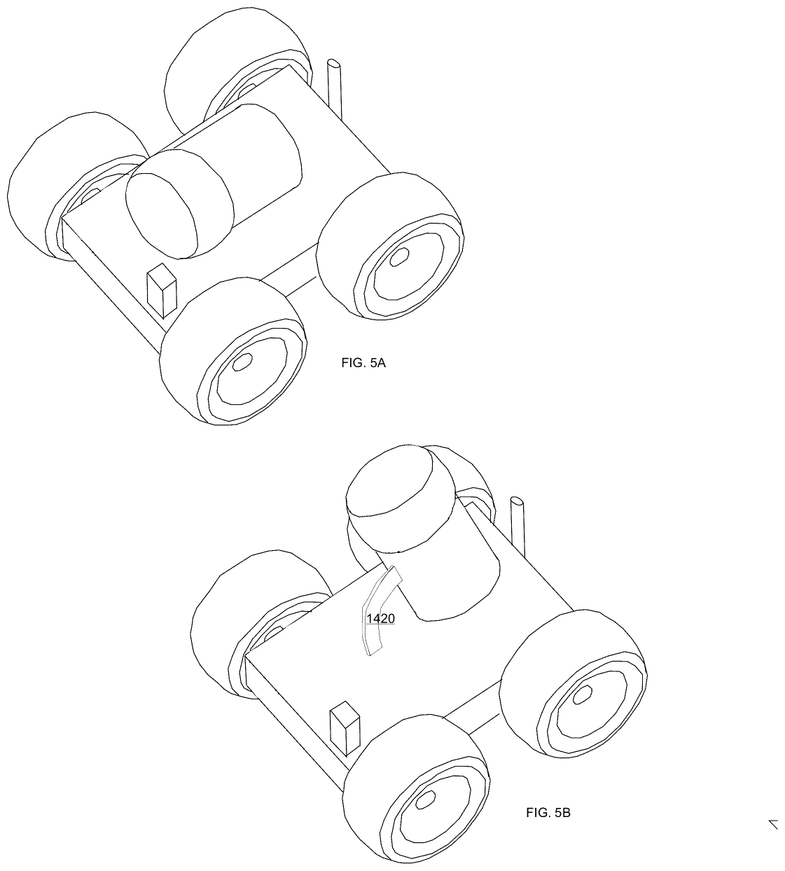

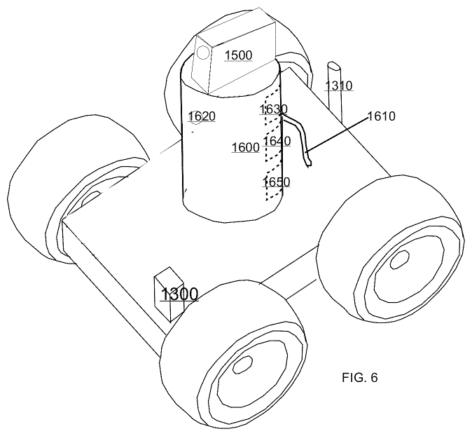

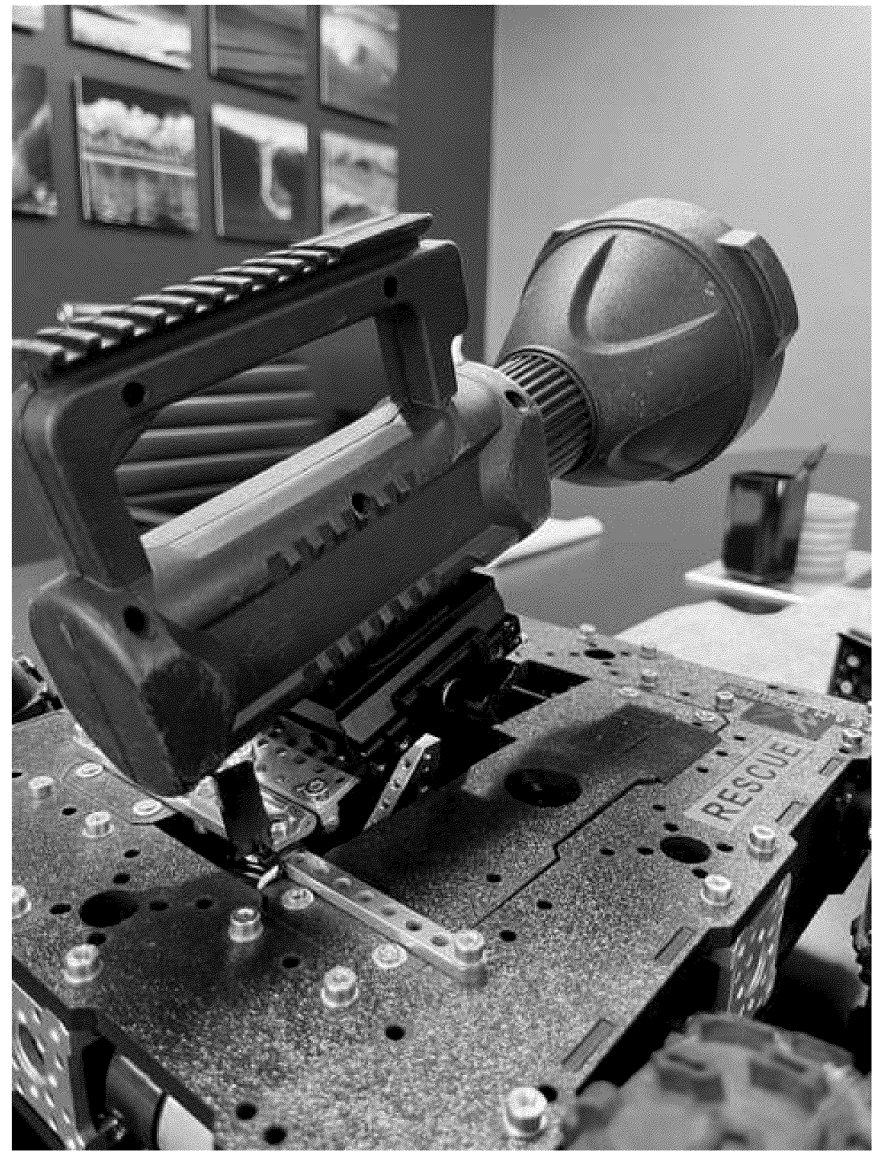

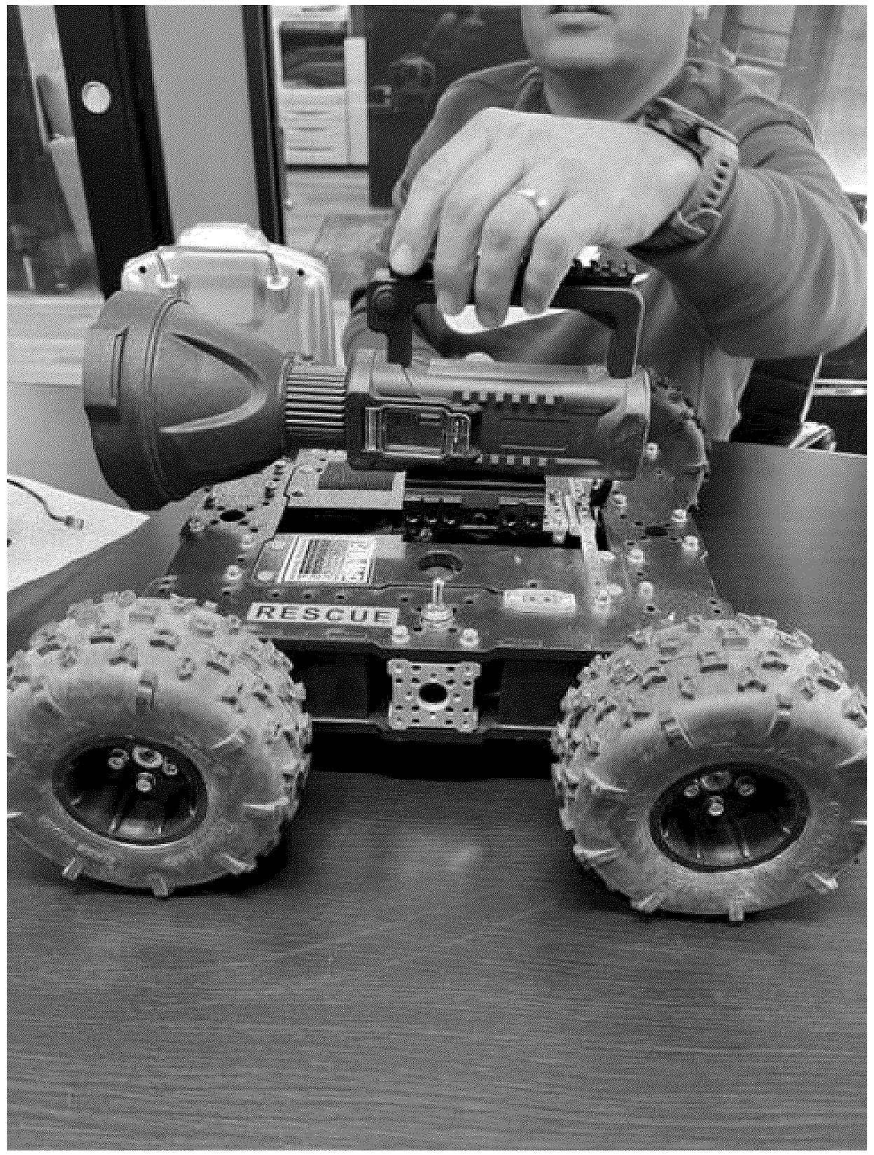

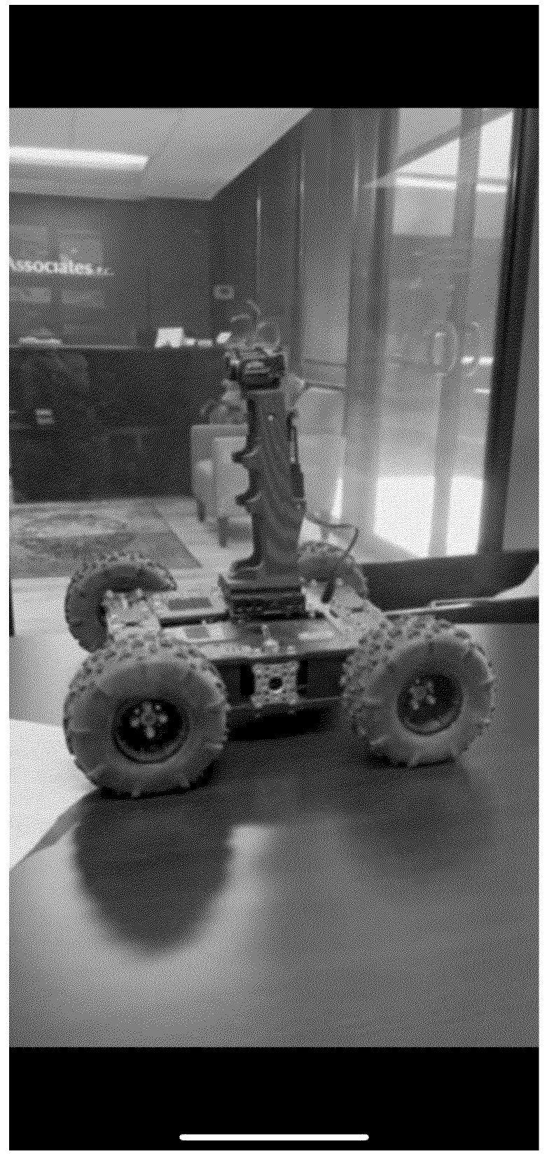

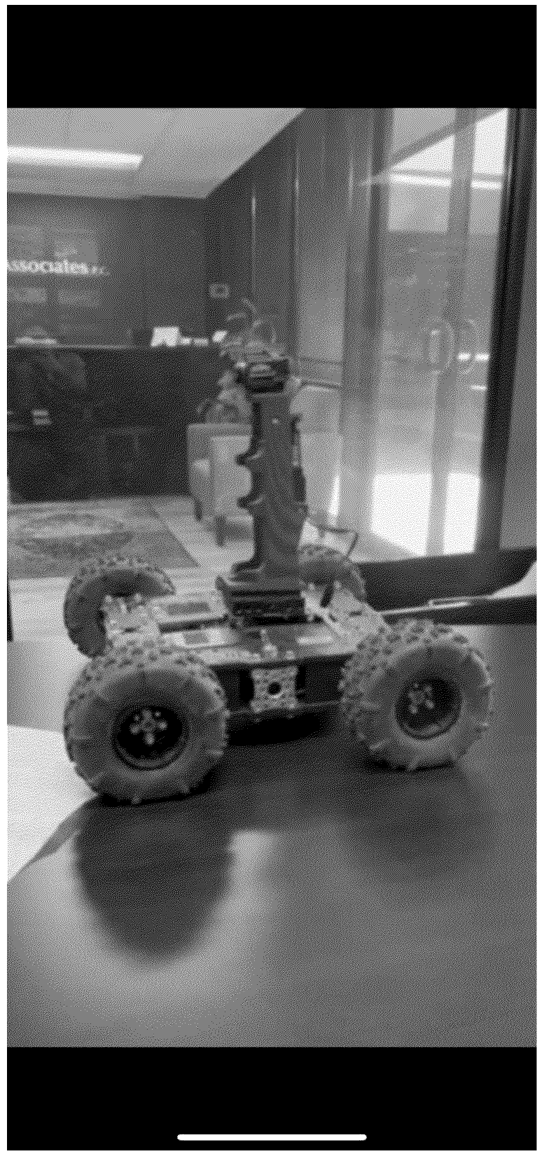

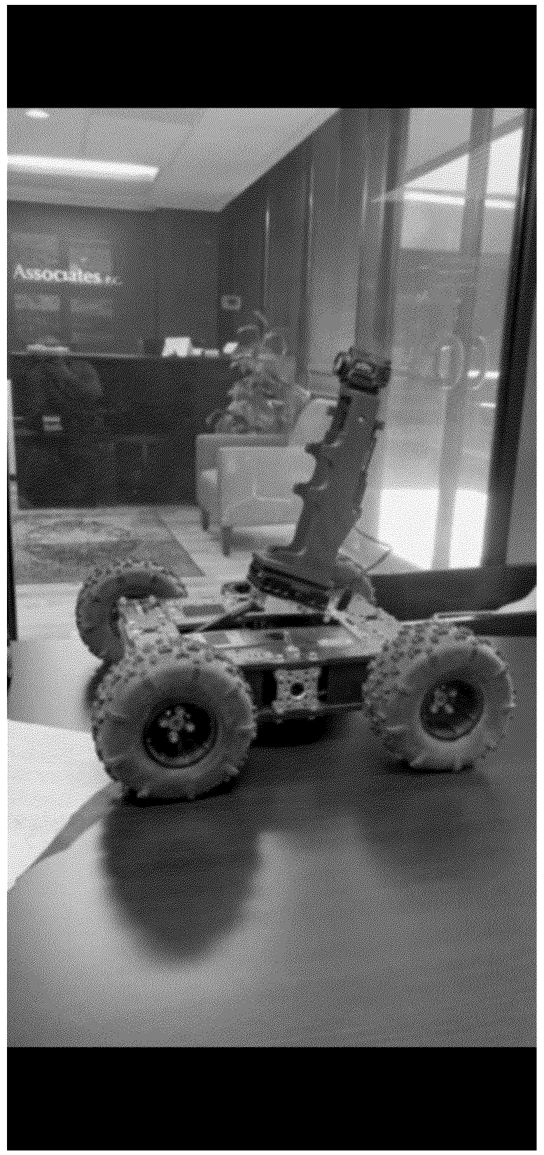

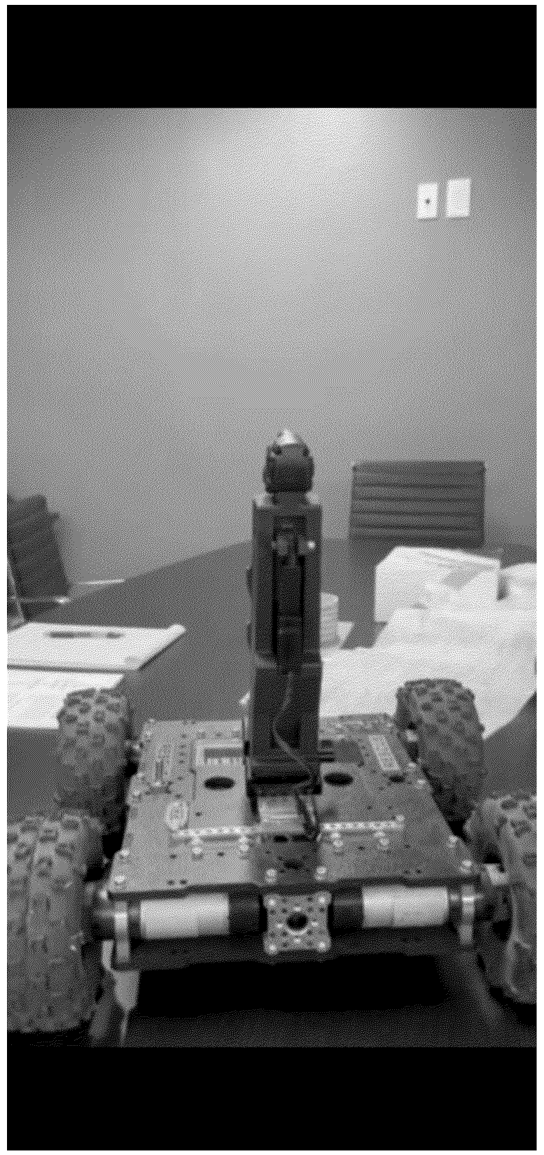

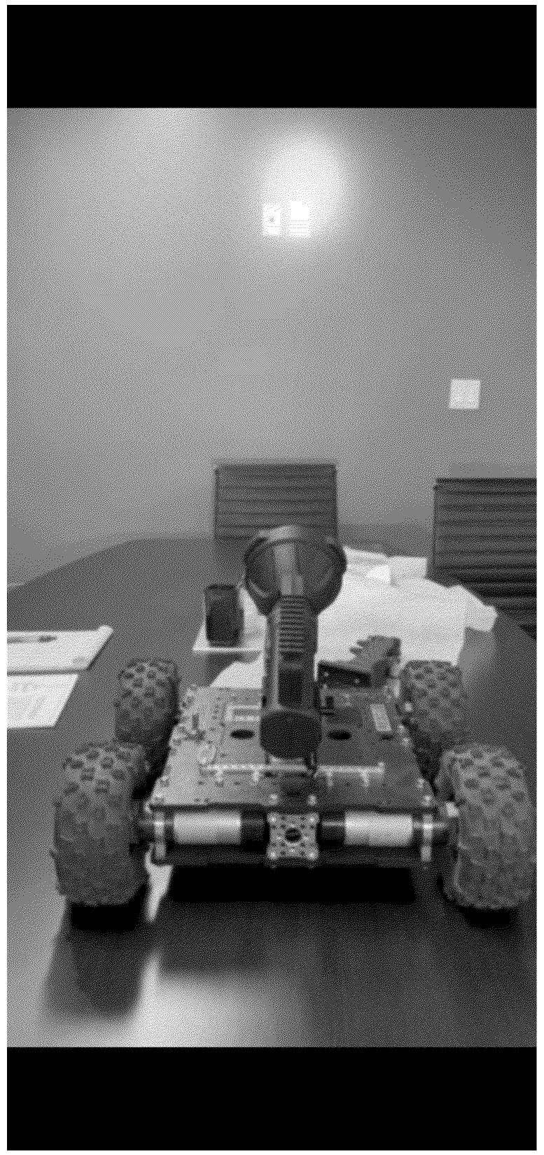

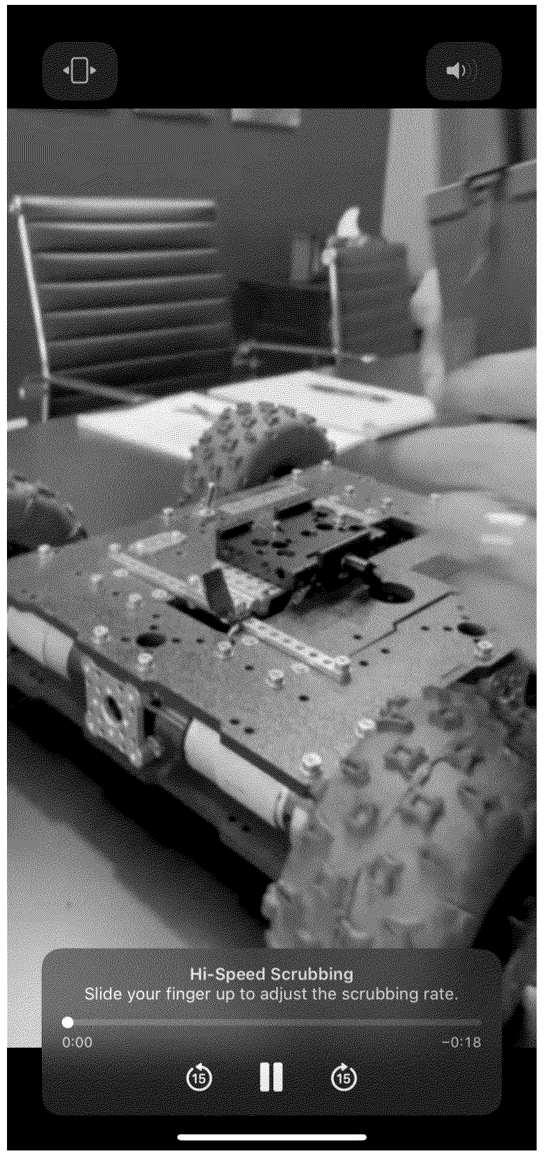

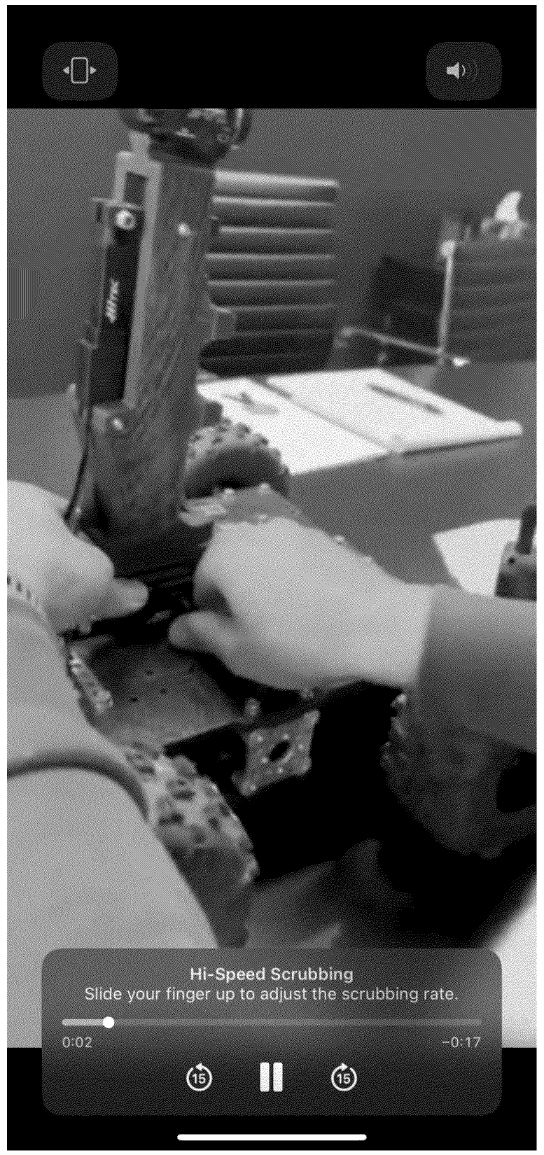

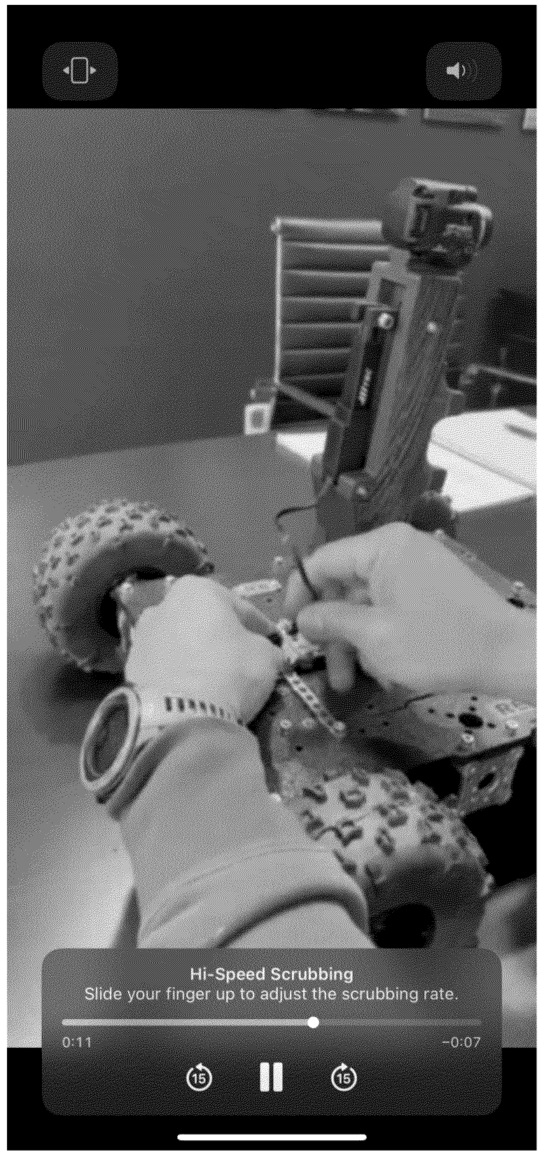

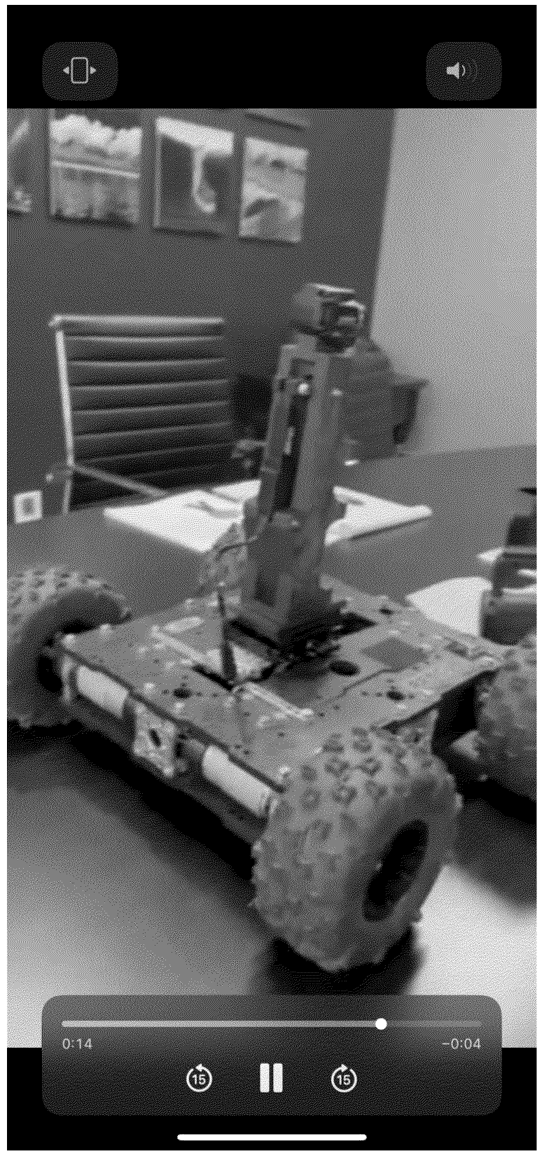

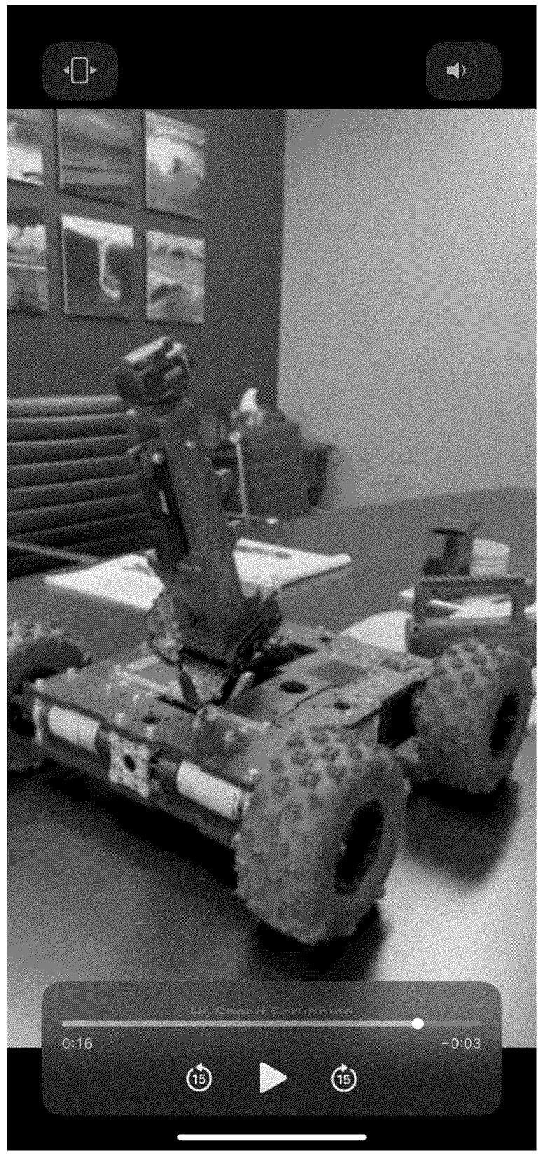

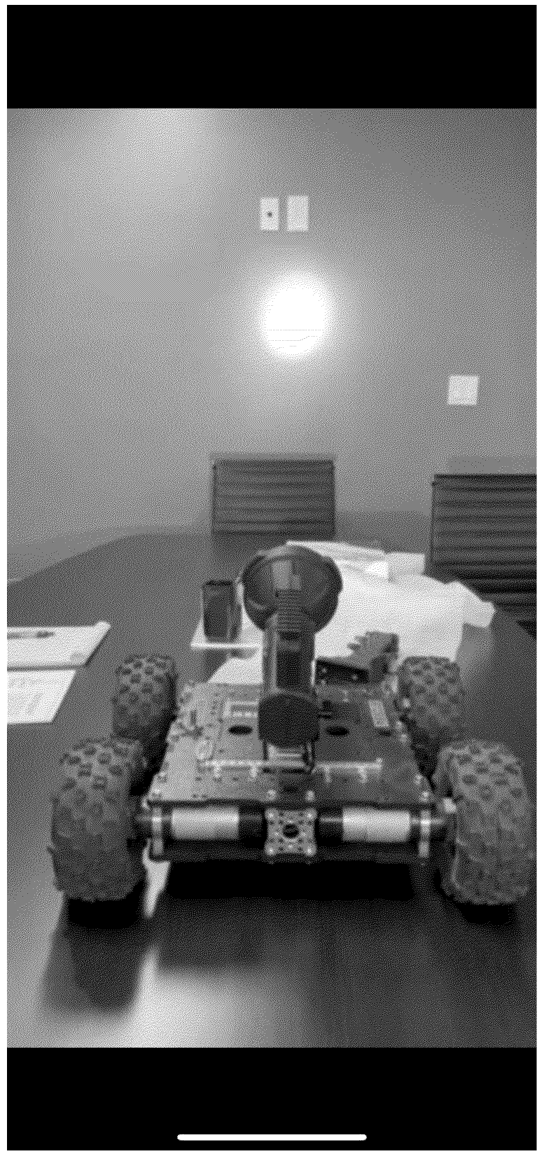

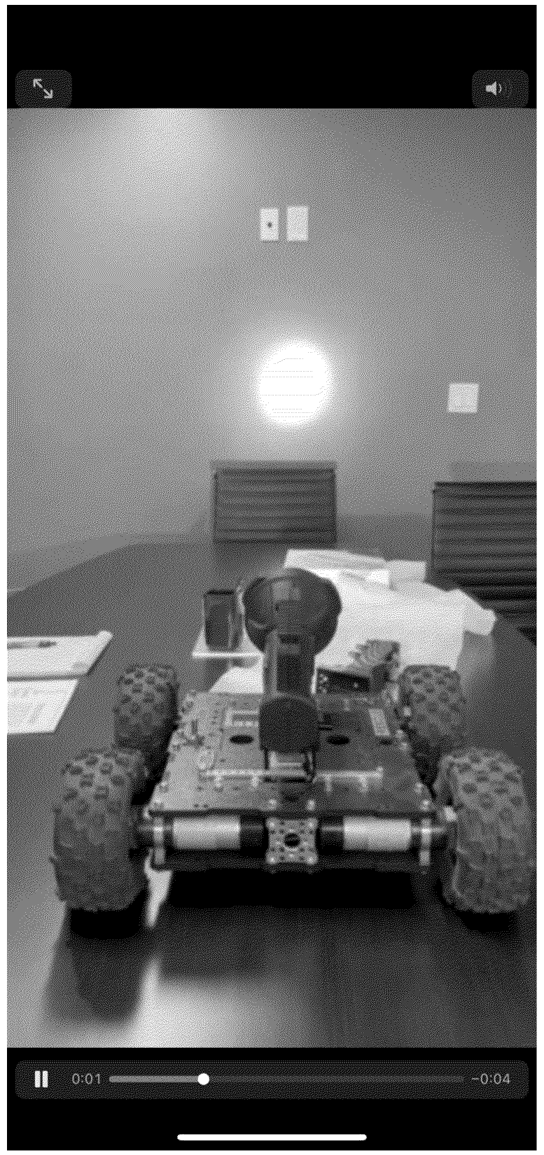

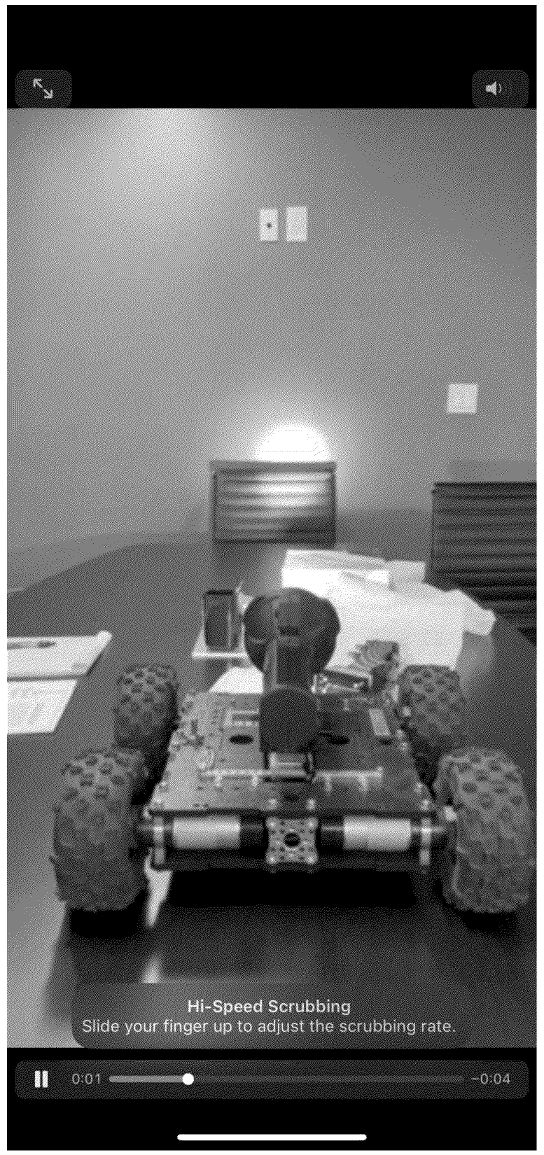

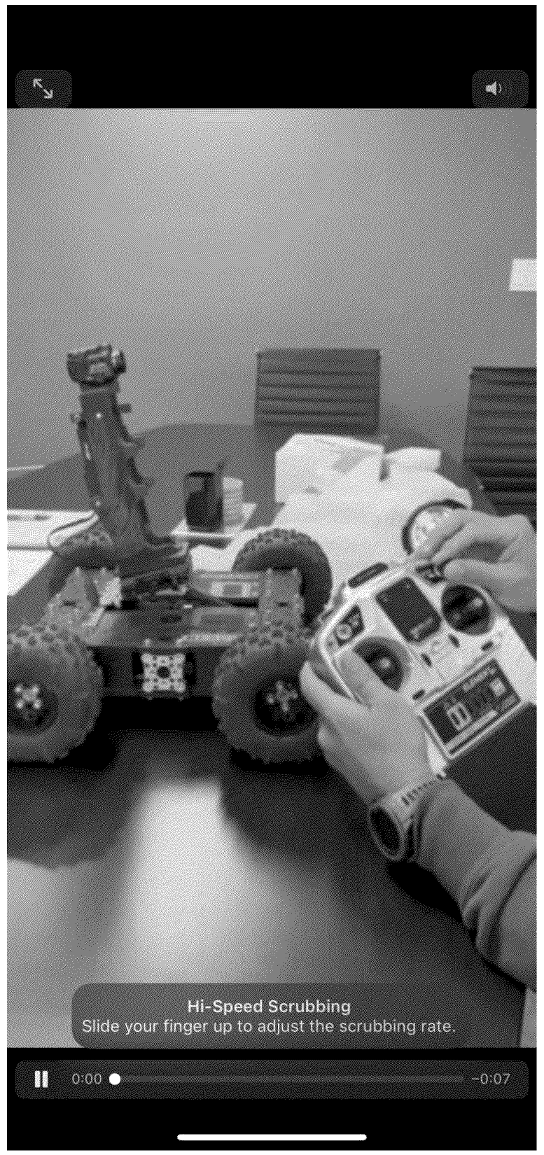

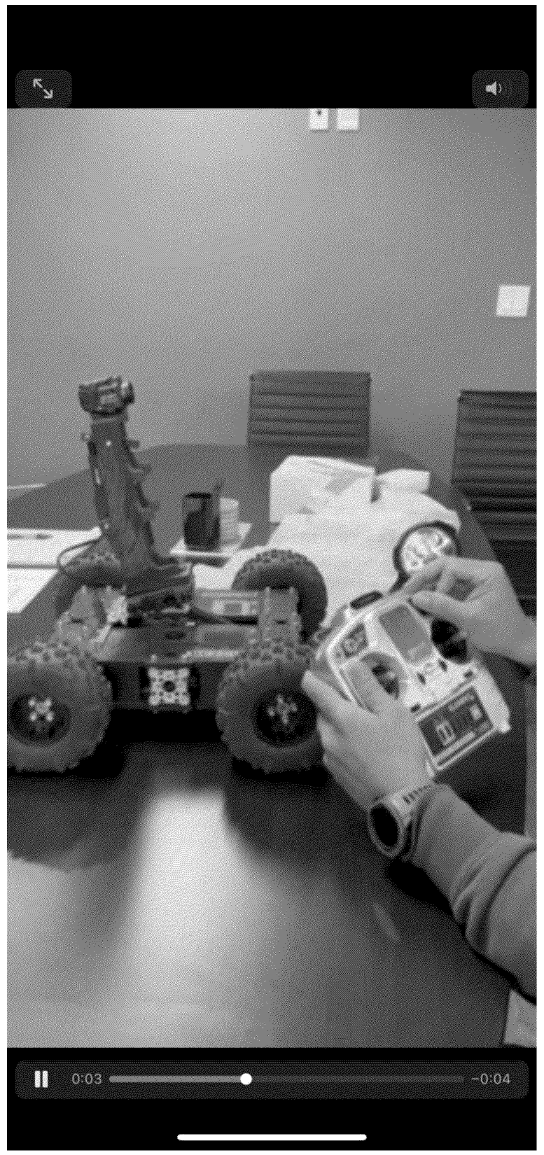

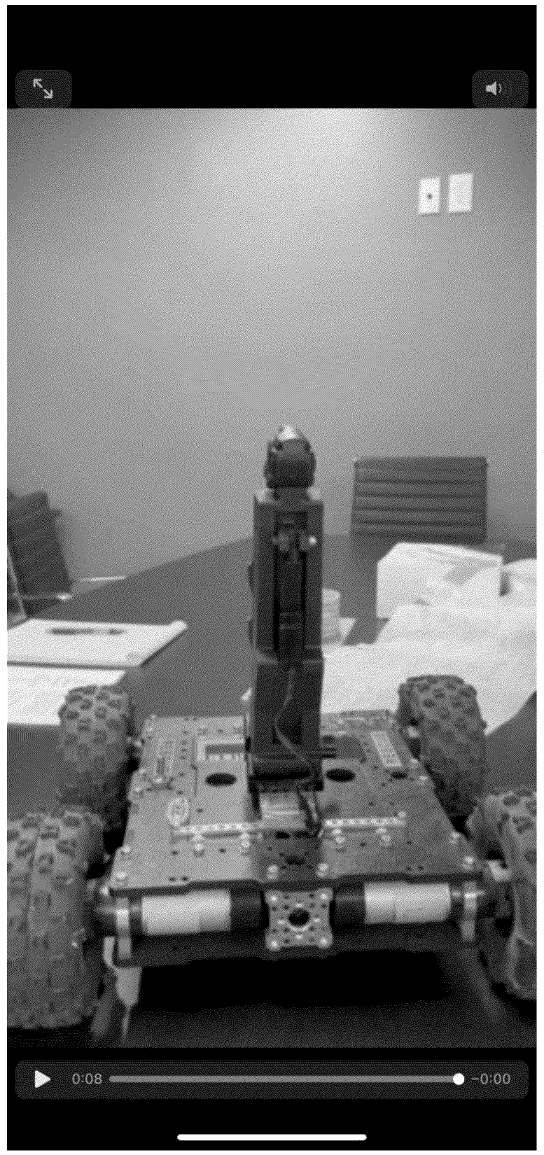

In the preferred embodiment displayed in FIG. 1, the spotlight 1500 is affixed to an attachment base 1400 extending from the top surface of the chassis 1100 of the mobile robotic device 1000. The spotlight 1500 is attached via clamps 1410 secured by a clamp screw 1411 into the attachment base 1400. In FIGS. 5A and 5B, the spotlight 1500 articulates through a lift 1420 (not shown in FIG. 1), allowing officers to adjust the angle of the light beam from 0 degrees (parallel to the chassis) to 90 degrees (perpendicular to the chassis). The chassis 1100 comprises four remote-controlled wheels 1200, with a live stream camera 1300 and its antenna/receiver 1310 situated on the outer surface, facilitating remote control by officers overseeing the scene. Suitably, the live-streamed images can be shown to the officers overseeing the scene via a display on the remote control or via the officer's phone or computer display or both.

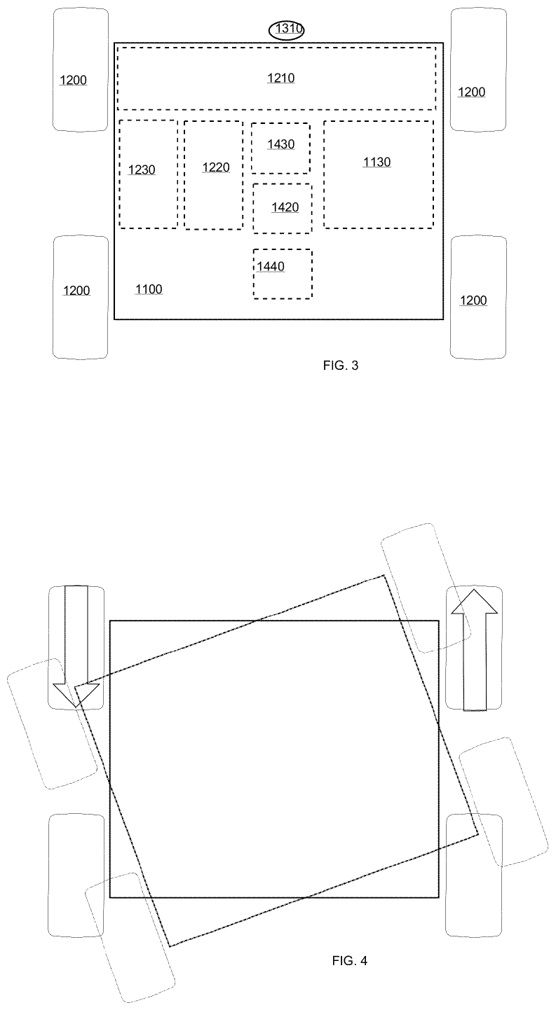

FIG. 3 is a schematic of the robotic officer 1000 that shows the preferred internal components of the robotic officer. As show the robotic officer 1000 contains a drive axle 1210 for the wheels 1200, at least one motor 1220 for the wheels 1200 that is connected to the drive axle 1200 to control the wheels collectively or independently, and a RC remote control receiver 1230 for remote control of the motor 1220. As shown, the robotic officer 1000 also contains lift 1420, a lift drive or motor 1430 and a lift RC receiver for remote control of the lift drive or motor 1430.

In FIG. 4, a demonstration illustrates remote control of the wheels 1200, showcasing how their opposite directions enable turning or pivoting, while moving in the same direction facilitates forward or backward movement of the officer 1000. As shown the wheels can be put in opposite directions to accomplish a turning or pivoting action of the robotic officer. This action can be accomplished via remote control signals received by the motor as would be common in the industry and well known in the art. The wheels can be put in the same direction to accomplish a forward or backward movement of the officer 1000.

FIGS. 5A and 5B depict a common scenario where the spotlight 1500 is used strategically. For instance, an officer may maneuver the robotic device using remote-controlled wheels, position the spotlight 1500 towards a window, and adjust it via the remote-controlled lift 1420. This strategic use of light denies visibility to suspects inside, creating a tactical advantage for officers while minimizing risks. In this example, the officer may use the remote-controlled wheels to place the spotlight 1500 in a preferred location, rotate the spotlight in the direction of a window and articulate the spotlight 1500 using the remote controlled lift 1420 so that its light beam is positioned directly on the window. As the light is shined inside the window, the person or persons inside are unable to see out of the window. This creates a tactical advantage for officers present at the scene. When a suspect is unable to see out of the window, they are unable to determine the actions that are being taken by officers, such as take down procedures. If a suspect is unaware of or unable to see the actions of police officers, the suspect will not be able to plan a response, attack or avoid apprehension, thereby allowing officers to achieve their objective while minimizing the risk to their personal safety.

Another feature in this invention is the removable live stream camera, offering a first-person view for remote monitoring. This camera can be magnetically attached to the robotic device or placed in a stationary position for discreet surveillance, ensuring officer safety. In one embodiment, a removeable live stream camera that may be attached at the anterior, posterior or other location on the top surface of the robotic device. The camera provides a first-person view to a remotely positioned monitor. In one embodiment, the camera is attached to the vehicle using a magnet. The removable live stream camera can remain on the robotic device to provide a live feed to officers who are positioned in a safe location. This allows officers to view the circumstances or activity at a given location without requiring a person to be physically present and potentially be placed in danger. In the alternative, the camera may be removed from the robotic device and placed in a desired, stationary position. The ability to remove the camera is advantageous because the camera can be more discretely hidden or placed in a higher position than would not otherwise be possible if the camera were attached to the remainder of the robotic device.

Yet another important component of the disclosed device is the spike strip or spike strip plate delivery mechanism. Additionally, the spike strip delivery mechanism is automated, eliminating the need for officers to be in close proximity during deployment. Some embodiments feature hooks or trap doors on the chassis to properly position the spike strip without endangering officers. While spike strip delivery mechanisms have become automated, prior art nevertheless requires that a person be physically involved and in close proximity to the deployment of a spike strip. Placing an officer in the path of a moving vehicle can be extremely dangerous in the event a suspect attempts to use their vehicle as a weapon to intentionally harm the officer. In addition, in the event the spike strip is successful, the driver may lose control of the vehicle and accidentally collide with the officer or any other person in the vicinity. In some embodiments, the chassis features a hook to drag or unfurl the spike strip or plate to the proper location. In other embodiments, the chassis features a trap door to drop or expel the spike strip at the desired location.

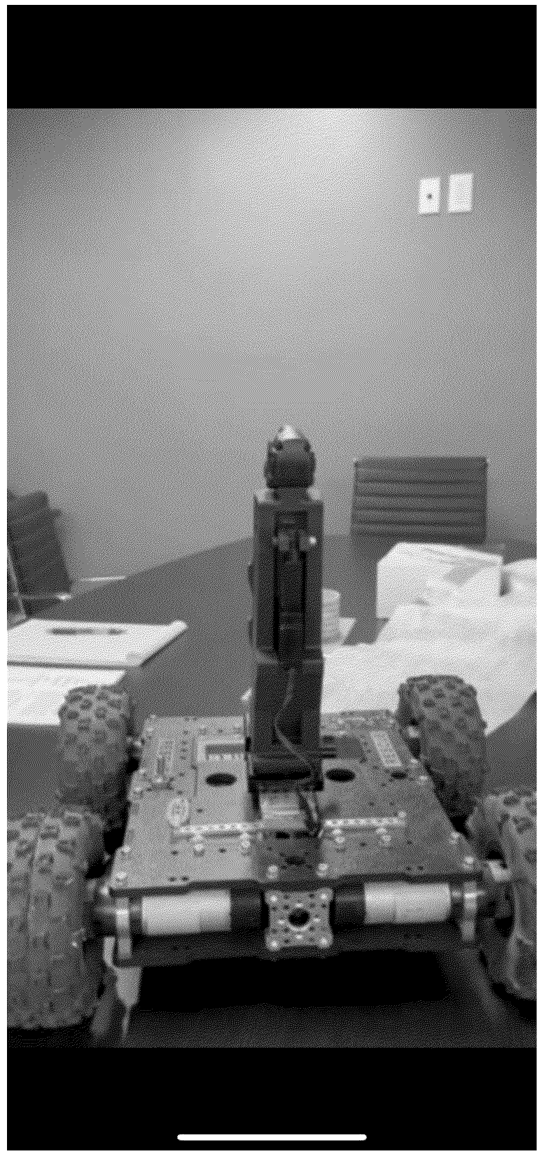

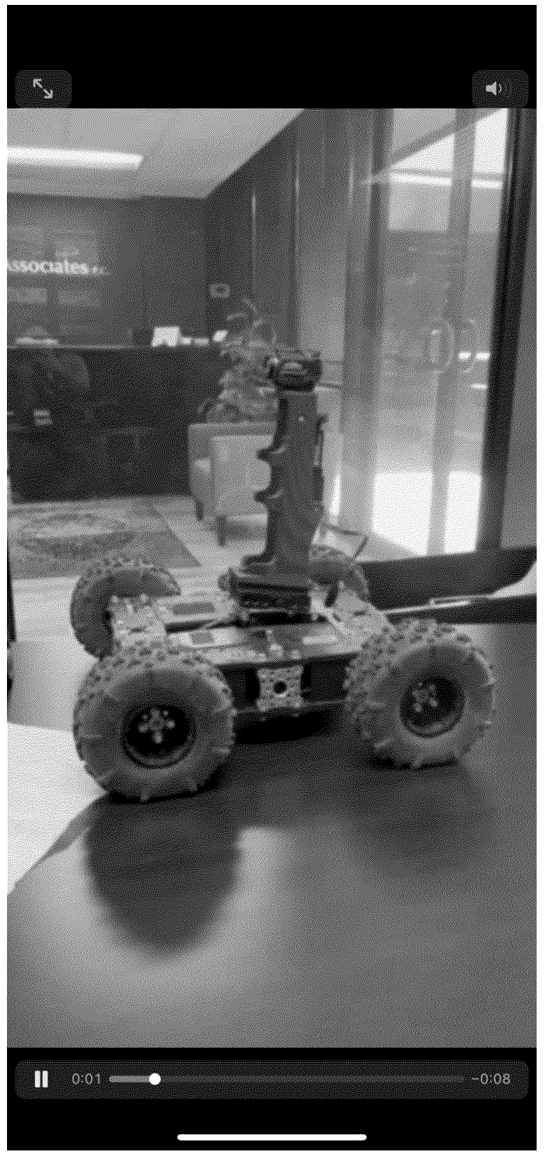

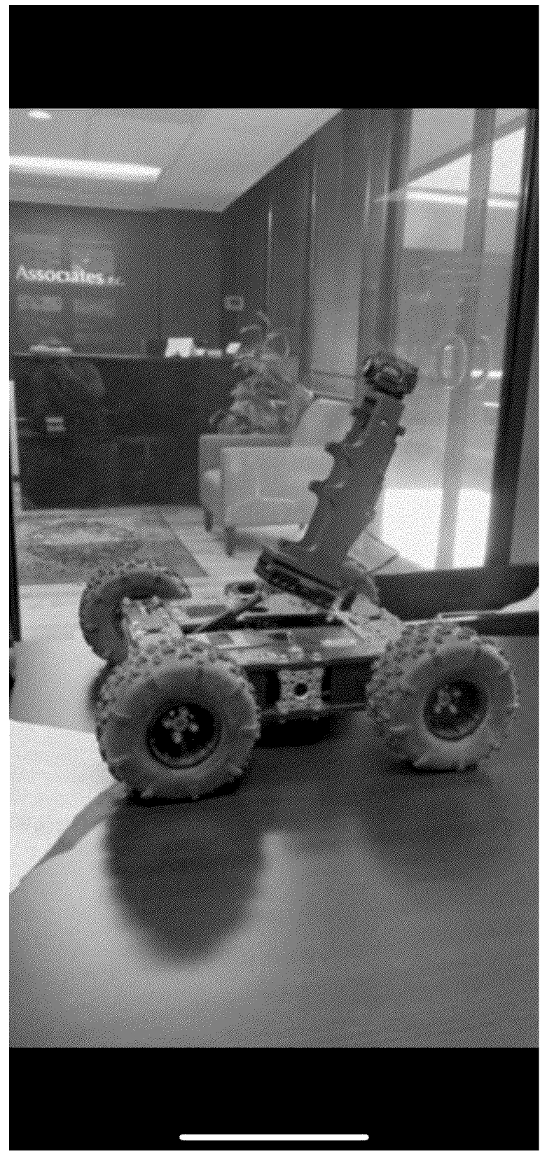

FIG. 6 shows an additional important component of the device is the chemical agent dispersal mechanism 1600. The chemical agent dispersal mechanism 1600, equipped with a nozzle 1620 and housing for a chemical agent, facilitates incapacitation from a distance. The mechanism incorporates a trigger 1630 connected to a remote trigger drive or motor 1640, operated via a remote control system, preventing officers from being in harm's way while using chemical agents. The mechanism 1600 may suitably be attached to the attachment base 1400 via the clamps in the same manner the spotlight 1500 was attached as discussed above in the earlier embodiments. This mechanism 1600 is suitably equipped with a nozzle 1620 and housing for carrying a chemical agent, such as pepper spray, to be deployed when the officer intends to incapacitate a suspect. In a preferred embodiment, the mechanism has a trigger 1630 that is connected to a remote trigger drive or motor 1640 that has a remote receiver 1650 to receive signals from a remote control (not shown) in the known manner. Prior art methods require an officer to come into close proximity with a suspect in order to utilize the chemical agent to impede a suspect. As expected, a suspect generally does not want to be sprayed with a chemical agent that could irritate or incapacitate them and result in apprehension. It is common for a suspect to resist being sprayed and direct the chemical agent towards the officer, resulting in harm to the officer from the chemical agent itself or from the suspect themselves immediately after being incapacitated. As with the earlier embodiments, the second embodiment may include a flashlight or laser pointing device 1500 atop the dispersal mechanism 1600 such that that the targeted culprit may be laser-sighted or spotlighted for aiming the spray mechanism. In these situations, it would be beneficial for emergency personnel to be out of harm's way to avoid injury while performing their duties.

FIGS. 5A and 5B imply a typical use scenario of the pepper spray mechanism 1600. For example, where a police officer wishes to spray a culprit, the officer may use the remote controlled wheels to place the mechanism 1600 in a preferred location, rotate the nozzle 1620 in the direction of a window and articulate the mechanism using the remote controlled lift 1420 so that its nozzle 1620 output is positioned directly on the culprit. As the spray is sprayed at the culprit, the person or persons are unable to see. This creates a tactical advantage for officers present at the scene. When a suspect is unable to see, they are unable to determine the actions that are being taken by officers, such as take down procedures. If a suspect is unaware of or unable to see the actions of police officers, the suspect will not be able to plan a response, attack or avoid apprehension, thereby allowing officers to achieve their objective while minimizing the risk to their personal safety. Moreover, the pepper spray mechanism (1600) significantly contributes to de-escalating police-culprit interactions. By deploying pepper spray remotely, the device 100 potentially incapacitates the culprit or creates enough distance for officers to employ additional de-escalation techniques before resorting to deadly or harmful force, thereby improving safety and minimizing confrontational outcomes.

Methods of using the device disclosed herein are also claimed. Detailed scenarios outlined in FIGS. 5A and 5B involve utilizing the spotlight (1500) strategically. For instance, officers can navigate the robotic device via remote-controlled wheels, position the spotlight (1500) towards a window, and articulate it using the remote-controlled lift (1420). By strategically directing light into the window, visibility is obstructed for suspects inside, offering a tactical advantage to officers while minimizing risks (see FIGS. 5A and 5B). Moreover, the pepper spray mechanism (1600) significantly contributes to de-escalating police-culprit interactions. By deploying pepper spray remotely, it potentially incapacitates the culprit or creates enough distance for officers to employ de-escalation techniques before resorting to deadly or harmful force, thereby improving safety and minimizing confrontational outcomes.

Detailed scenarios outlined in FIGS. 5A and 5B highlight the precise control of the spotlight (1500) or pepper spray mechanism (1600). Officers can navigate the robotic device via remote-controlled wheels (1200) to position the spotlight (1500) or pepper spray mechanism (1600) left or right. Simultaneously, articulating the lift (1420) allows officers to adjust the spotlight's (1500) or pepper spray mechanism's (1600) elevation, ensuring complete coverage of an area by the light beam or spray (refer to FIGS. 5A and 5B). Not only will this device make situations safer for officers, it will also make the situation much safer for the culprit. Dealing with a culprit at further distances, allows for police officers to process threats more effectively. Effectively processing a culprit's actions, gives police officers the ability to utilizing the appropriate tools to respond to the culprit's actions. Close distance encounters are much more dynamic and sometimes force police officer to make split second decisions to protect themselves. When in close proximity to a culprit, a police officer may not have a choice, but to resort to deadly force to stop a culprit's threatening advance. Distance will give the officer the ability to utilize a less than lethal option. Effectively utilizing a less than lethal option may save the culprit's life.

Some portions of the detailed descriptions that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The present invention also relates to an apparatus for performing the operations herein. This apparatus is specially constructed for the required purposes, or it comprises a general-purpose computer selectively activated or reconfigured by a computer program stored in the computer. Such a computer program is stored in a computer-readable storage medium such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media, suitable for storing electronic instructions, and each coupled to a computer system bus.

The algorithms and displays presented herein are not inherently related to any particular computer or other apparatus. Various general-purpose systems are used with programs according to the teachings herein, or more specialized apparatuses are constructed to perform the required method steps. The required structure for a variety of these systems will appear from the description below. In addition, the present invention is not described with reference to any particular programming language. It will be appreciated that a variety of programming languages can be used to implement the teachings of the invention as described herein. It is understood that this invention is not limited to only the elements described herein and that other types of elements will be equivalent for the purposes of this invention. The invention has been described by referencing preferred embodiments and several alternative embodiments, however one of ordinary skill in the art understands that employing other variables and modifications does not depart from the spirit and the scope of the present invention.

Although the invention has been disclosed in terms of specific embodiments herein, in light of these teachings, one of ordinary skill in the art may generate additional embodiments and modifications without departing from the spirit or the scope of the claimed invention. It is understood that the examples and descriptions disclosed herein are merely to facilitate understanding of the invention and should not be construed to limit the scope thereof.

It is also contemplated that the present invention may also apply in other industries, including, but not limited to, the sale of other types of goods. It is understood that this invention is not limited to only the data, variables, or elements described herein. That other types of data, variables, or elements will be equivalent for the purposes of this invention. The invention has been described by referencing preferred embodiments and several alternative embodiments; however, one of ordinary skill in the art understands that employing other variables and modifications does not depart from the spirit and the scope of the present invention.

Although the invention has been disclosed in terms of specific embodiments herein, in light of these teachings, one of ordinary skill in the art may generate additional embodiments and modifications without departing from the spirit or the scope of the claimed invention. It is understood that the examples and descriptions disclosed herein are merely to facilitate understanding of the invention and should not be construed to limit the scope thereof.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. a controllable robotic officer equipped with an articulating spotlight, removable camera, spike strip delivery, and chemical agent dispenser, aiding law enforcement in minimizing risks during emergencies.
